(19) United States
(12) Patent Application Publication
(10) Pub. No.: US 2017/0186091 A1
(43) Pub. Date: Jun. 29, 2017

(54) GOVBRAIN™ METHOD, APPARATUS, AND COMPUTER SOFTWARE

(71) Applicant: GovBrain Inc., Washington, DC (US)

(72) Inventors: Brent M. Eastwood, Santa Fe, NM (US); Dustin Brand, Albuquerque, NM (US)

(21) Appl. No.: 15/457,343

(22) Filed: Mar. 13, 2017

Related U.S. Application Data
(63) Continuation of application No. 14/323,622, filed on Jul. 3, 2014.
(60) Provisional application No. 61/842,708, filed on Jul. 3, 2013.

(51) Int. Cl. G06Q 40/06; G06Q 40/04; G06Q 50/26

(52) U.S. Cl. CPC G06Q 40/06; G06Q 50/26; G06Q 40/04

(57) ABSTRACT

An apparatus for, computer software for, and automated method of predicting security price fluctuations comprising identifying potentially relevant news and government information relating to the security, parsing the potentially relevant news and government information, determining relevance of the potentially relevant news and government information to the security, and predicting a price move strength and direction for the security based upon relevance.

### CROSS-REFERENCE TO RELATED APPLICATIONS

This application is a continuation of U.S. patent application Ser. No. 14/323,622, entitled “GOVBRAIN™ METHOD, APPARATUS, AND COMPUTER SOFTWARE”, filed on Jul. 3, 2014, which claims priority to and the benefit of the filing of U.S. Provisional Patent Application No. 61/842,708, filed on Jul. 3, 2013, and the specification and claims thereof are incorporated herein by reference.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### COPYRIGHTED MATERIAL

Not Applicable.

### BACKGROUND OF THE INVENTION

Field of the Invention (Technical Field)

The present invention relates to methods, apparatuses, and computer software for predictive analysis based on public information, particularly as relating to predicting securities price movements.

Description of Related Art

The present ability to quickly receive, correlate, and act on publicly available news information, particularly items associated with governmental activities, is ad hoc. The present invention provides an automated means by which such information can be gathered, correlated (such as to related stock), and acted upon (such as a buy or sell order).

### BRIEF SUMMARY OF THE INVENTION

The present invention is of an apparatus for, computer software for, and automated method of predicting security price fluctuations, comprising: identifying potentially relevant news and government information relating to the security; parsing the potentially relevant news and government information; determining relevance of the potentially relevant news and government information to the security; and predicting a price move strength and direction for the security based upon relevance. In the preferred embodiment, the invention additionally archives predicted price move strength and direction and actual price move strength and direction. All potentially relevant news and government information is public information. A source of the potentially relevant news and government information is one or more RSS XML feeds from one or more of municipal, state, federal, international governments, international bodies, and quasi-governmental organizations. A user can specify information feeds to be searched and search keywords associated with the security. The invention preferably operates on a plurality of securities simultaneously. The automated prediction engine is preferably trained via a human expert.

Further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE VIEWS OF THE DRAWINGS

The accompanying drawings and those in the attachment, which are incorporated into and form a part of the specification, illustrate one or more embodiments of the present invention and, together with the description, serve to explain the principles of the invention. The drawings are only for the purpose of illustrating one or more preferred embodiments of the invention and are not to be construed as limiting the invention. In the drawings:

FIG. 1 is a logic tree that denotes the flow of programming for the prediction engine of the invention;

FIG. 2 is a screen shot of the GovBrain Search Web App of the invention;

FIG. 3 is a screen shot of the main GovBrain Web App With Predictive Analysis for Security Prices tool of the invention;

FIG. 4 is a screen shot of the GovBrain Political Event Database of the invention;

FIG. 5 provides the preferred data structure for the error log entity in an embodiment of the invention;

FIG. 6 provides the preferred data structure for the feeds entity in an embodiment of the invention;

FIG. 7 provides the preferred data structure for the keywords entity in an embodiment of the invention;

FIG. 8 provides the preferred data structure for the posts entity in an embodiment of the invention;

FIG. 9 provides the preferred data structure for the tblBonds entity in an embodiment of the invention;

FIG. 10 provides the preferred data structure for the tblCommodities entity in an embodiment of the invention;

FIG. 11 provides the preferred data structure for the tblCurrencies entity in an embodiment of the invention;

FIG. 12 provides the preferred data structure for the tblDefaultStock entity in an embodiment of the invention;

FIG. 13 provides the preferred data structure for the tblEvents entity in an embodiment of the invention;

FIG. 14 provides the preferred data structure for the tblGovRules entity in an embodiment of the invention;

FIG. 15 provides the preferred data structure for the tblGovSites entity in an embodiment of the invention;

FIG. 16 provides the preferred data structure for the tbINASDAQ entity in an embodiment of the invention;

FIG. 17 provides the preferred data structure for the tbINYSE entity in an embodiment of the invention;

FIG. 18 provides the preferred data structure for the tblSectors entity in an embodiment of the invention; and

FIG. 19 provides a preferred relational schema for the tables of FIGS. 5-18.

### DETAILED DESCRIPTION OF THE INVENTION

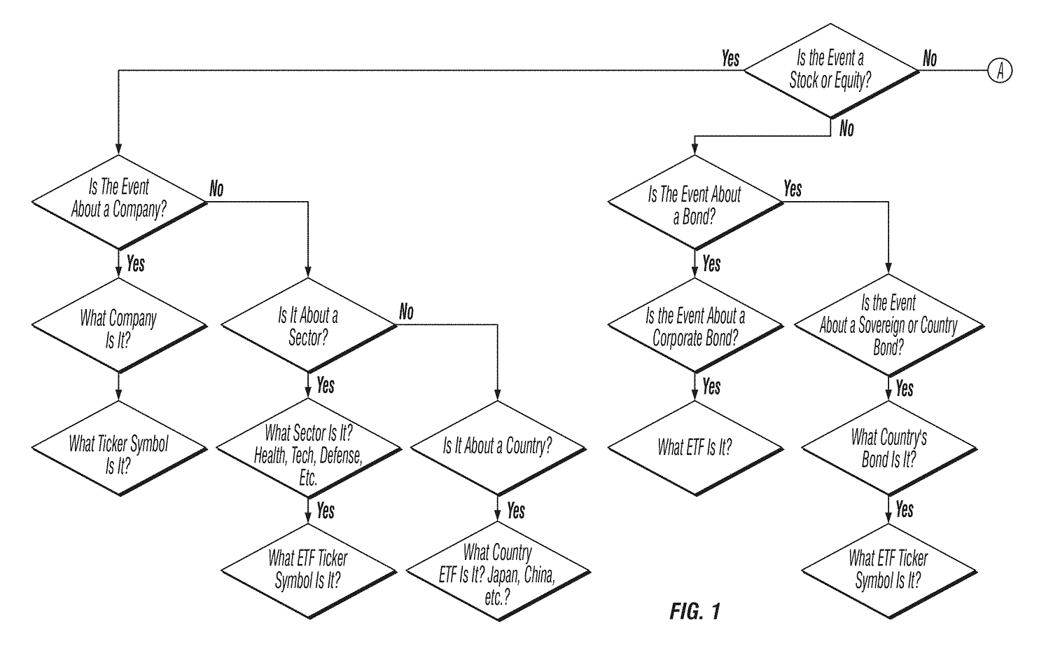

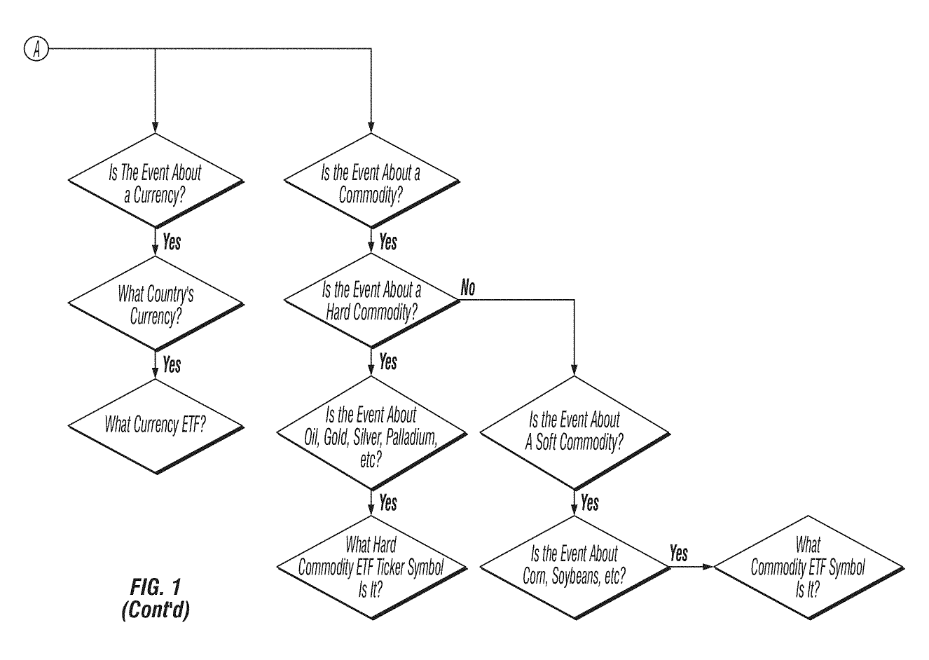

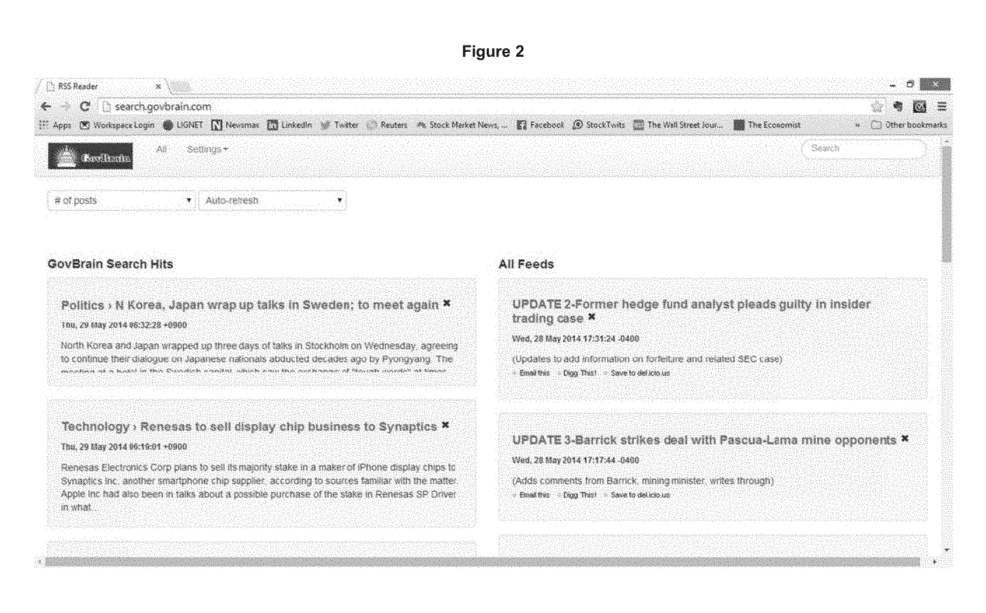

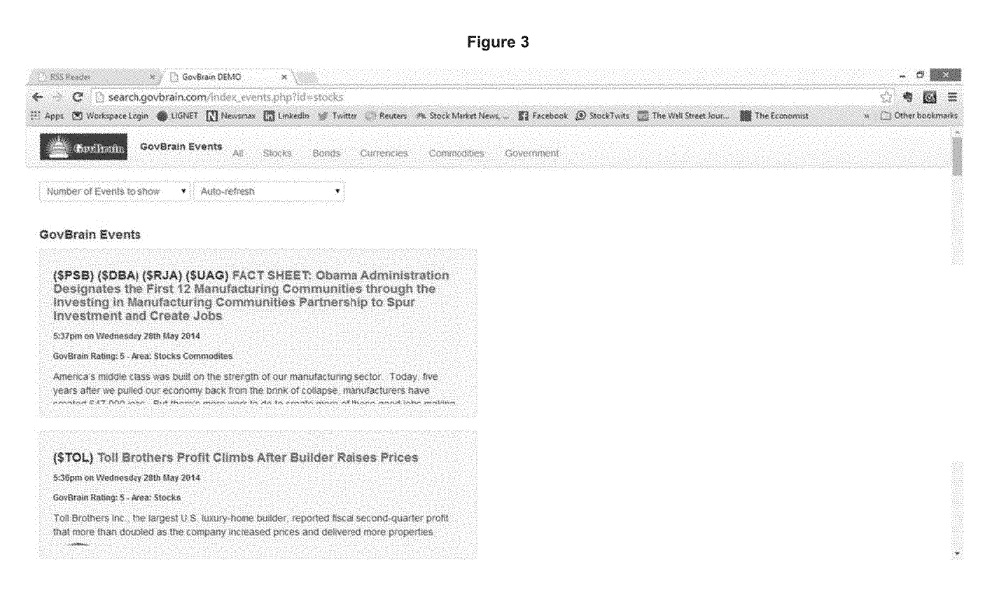

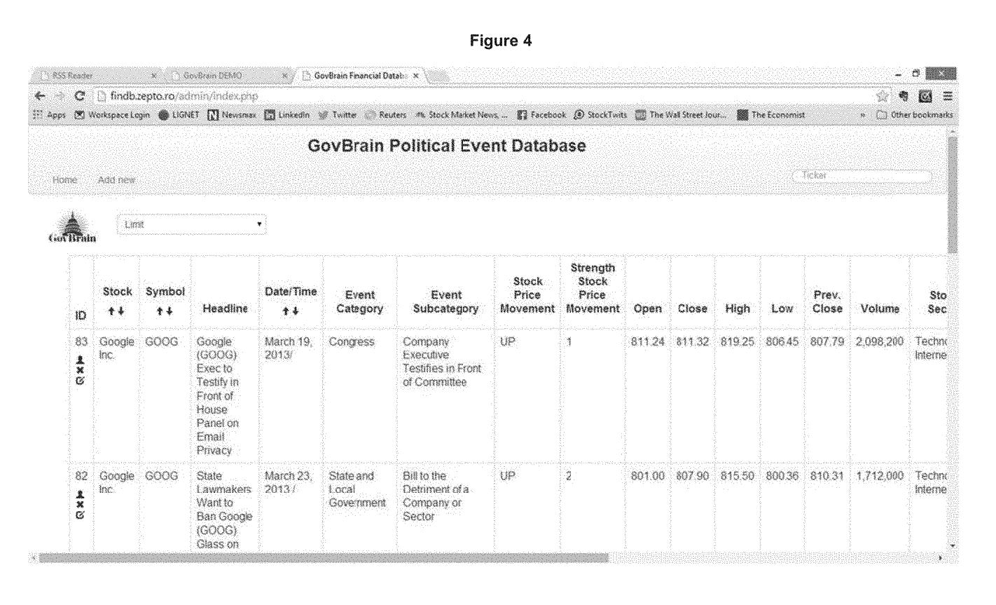

The present invention provides security price predictions based on governmental decisions, regulatory actions and political events. These include new laws, administrative rulings, regulatory findings, legislative votes, public policy decisions, and political developments and elections. Investors and traders, using GovBrain web applications, can leverage this information to gain a competitive advantage in their trading and investing by anticipating developments that affect various securities and contracts. The invention is a system that first uses a proprietary search engine web application that searches and parses information from government web sites and news sites. This information comes from municipal, state, U.S. Congressional, U.S. federal and international governments in order to facilitate better securities trades using intelligence gathered from political and government events. The proprietary search engine (see FIG. 2) is used to find or discover government or political events. A second web application (see FIG. 3) captures these events and then matches them to a stock, bond, commodity or currency (each of which is a “security” within the meaning of the specification and claims). The second web application also serves as a proprietary prediction engine (see FIG. 1) that automatically predicts the direction of the security price move and the strength of that price move for securities. The predictive analytics for the security prices are the result of a novel use of artificial intelligence and machine learning. A third web application (see FIG. 4) comprises an automated database or archival system that stores GovBrain price predictions and events. This application automatically archives each government event along with key statistics for the financial services industry such as the ticker symbol, date, time, GovBrain price prediction, intensity of price moves, open, close, high, low, volume, 52-week range, and various moving averages.

The GovBrain search engine web application searches hundreds of global databases and web sites that have news or information on governmental and regulatory decisions. This search engine automates the old-fashioned political intelligence collection process and makes it more efficient, faster and cheaper for the user. Another GovBrain application matches the events to relevant securities. The prediction engine then predicts the price move for the security.

The invention provides a full research and trading system for better securities trading by contributing to a novel political intelligence event database. The automated political event archive application keeps track of the various political events, the time and date of the event, the security ticker symbol, the price prediction, the strength of the price prediction, and various statistics used by financial industry experts such as the particular trading day price open, close, volume, high, low, moving average, etc. The automated archive application provides a novel use of political event data.

The search engine can search an unlimited number of RSS XML feeds from city government, state government, federal government and international governments along with an unlimited number of search terms or key words. It can search every U.S. and international company listed on the Dow Jones Industrial Average, NASDAQ, the New York Stock Exchange and virtually all companies publicly listed around the world. Searches can also be conducted on bonds, currencies and commodities around the world.

Relying on public information, the GovBrain web applications avoid violation of any portion of the STOCK Act of 2012. The application makes use of public information provided on government web sites and data bases and also government information and actions covered in the media.

There is no “insider” trading taking place with this web application. No members of Congress, Congressional staff, or government employees are personally consulted in the process. No lobbyists, consultants or law firms are consulted on the process.

The invention differs from what currently exists. No other web application that searches existing state legislative and federal government databases and web sites around the world is also used for a “macro” securities trading strategy based on governmental and political events.

The invention aids in recognition of the links between governmental decisions, regulatory rulings, legal decisions, administrative rulings, new laws or rules, votes in Congress, regulatory oversight of industries, Presidential actions, and any type of governmental action around the world.

The invention also aids creation of a number of databases that automatically connect the above actions and link them to a stock, security, exchange traded fund, or industry sector, as well as the employment of artificial intelligence techniques to successfully predict a security price move and the strength or intensity of that security price move.

The web applications for the search engine and prediction engine produces the information for a political event data base for technical analysis and momentum analysis to provide a unique, unobvious and novel stock picking and stock investment strategy. These web applications can also offer broad data for political and public policy analysis of the governmental event and analysis of how it relates to financial markets around the world.

Also, an additional web application produces the information for the previously-mentioned political event archive that can be used for technical analysis and momentum analysis to provide a security selection and security investment strategy. This includes traders, analysts and investors who use the “macro” style of investing. Macro investing means holding short or long positions in stocks, bonds, currencies, commodities and derivatives that trade on exchanges all over the world.

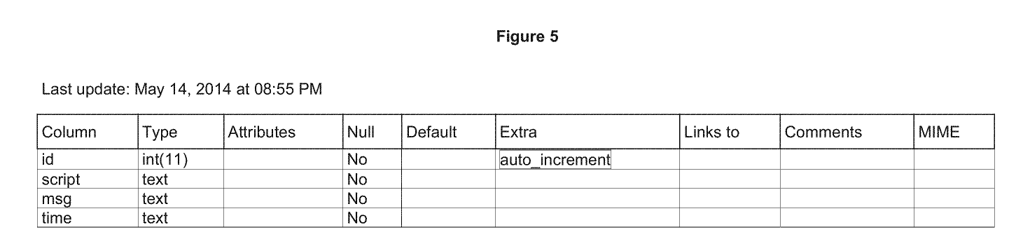

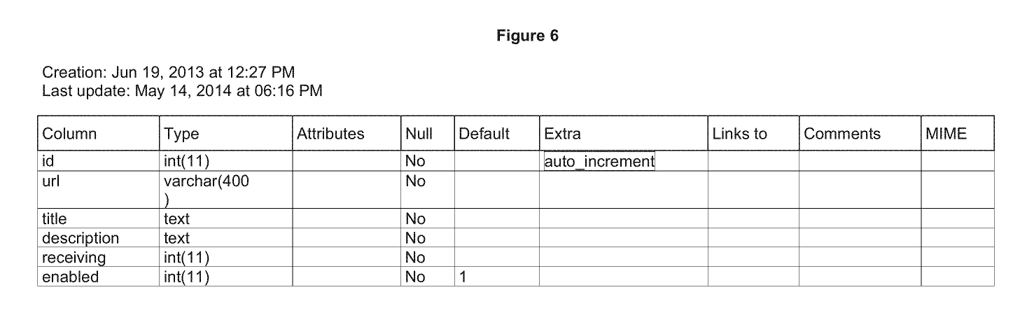

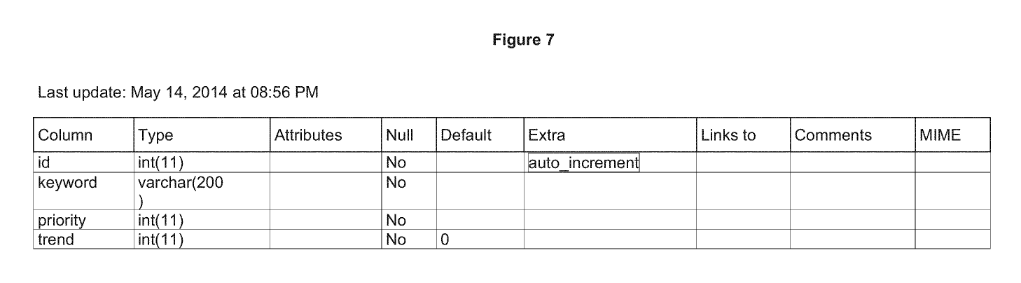

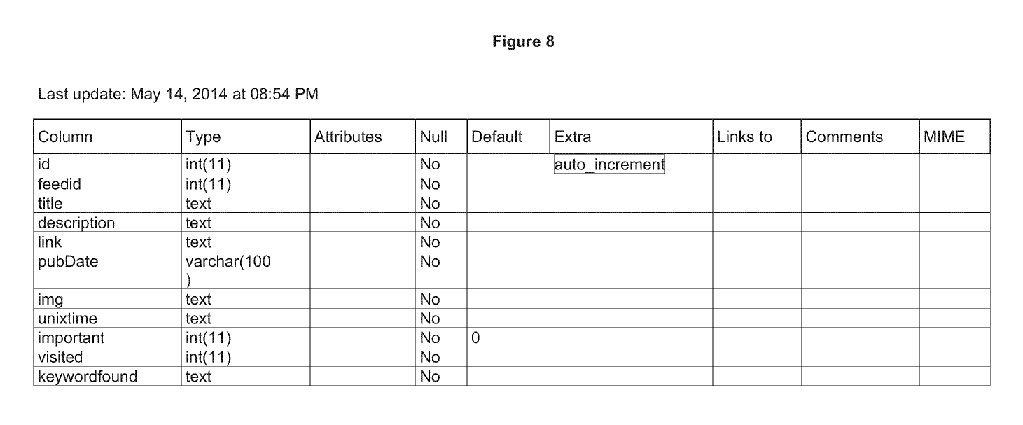

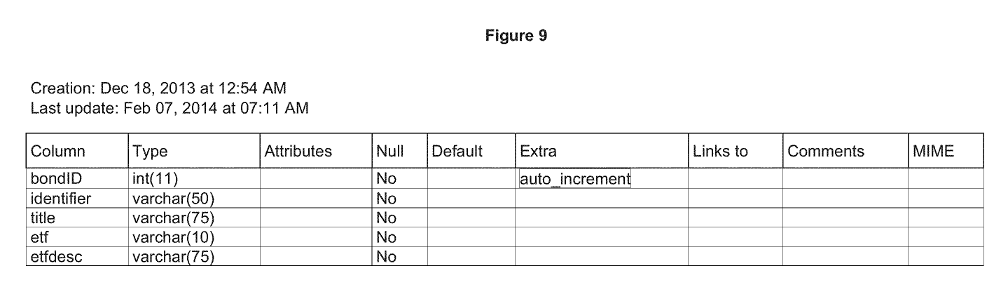

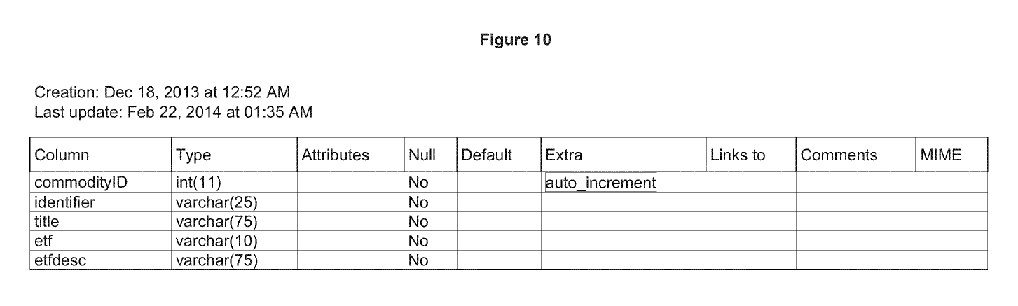

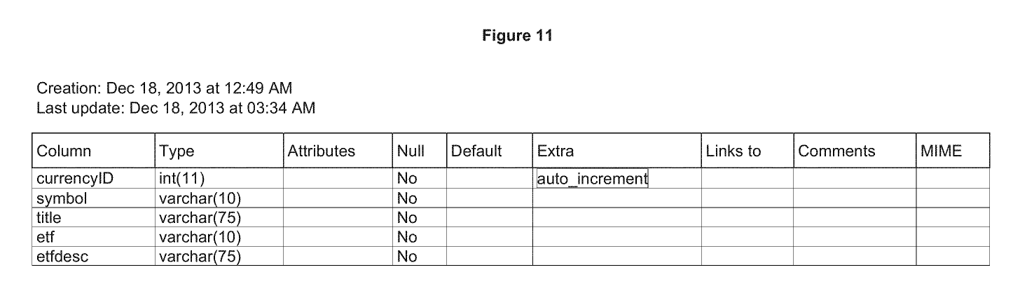

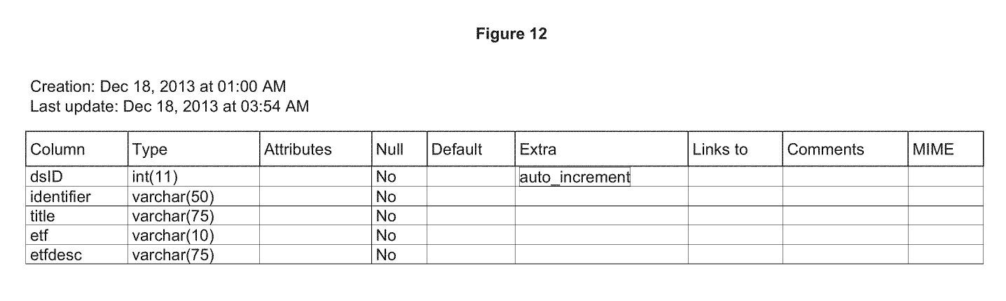

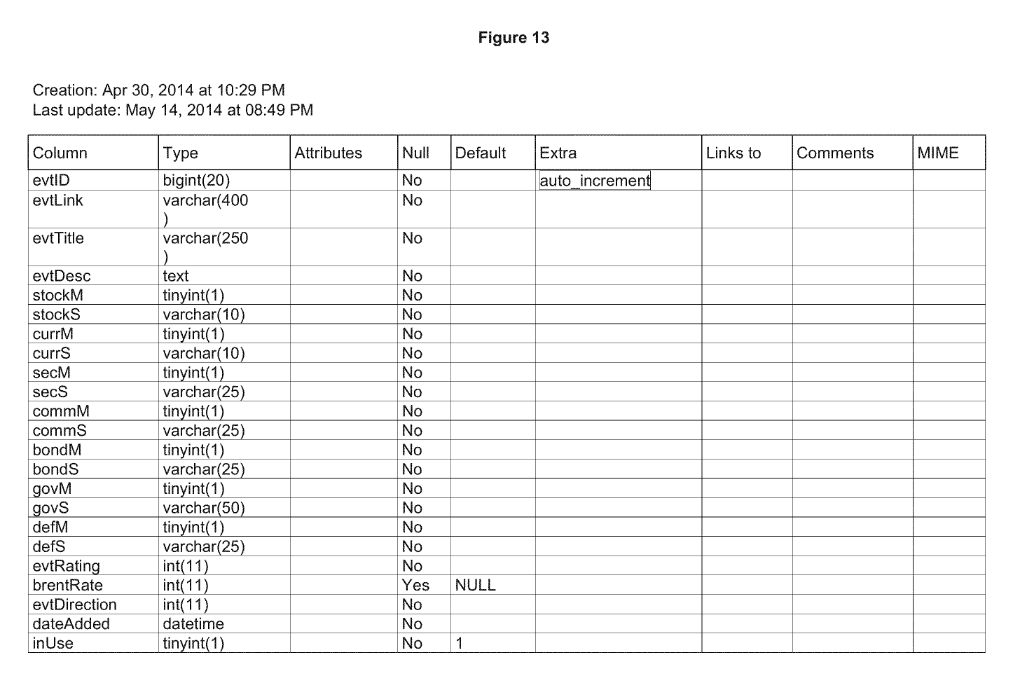

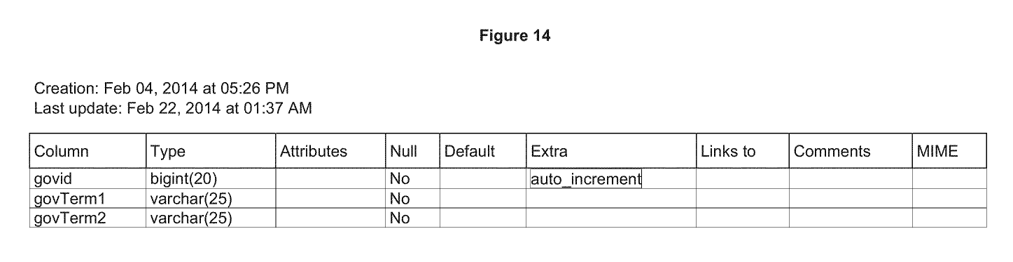

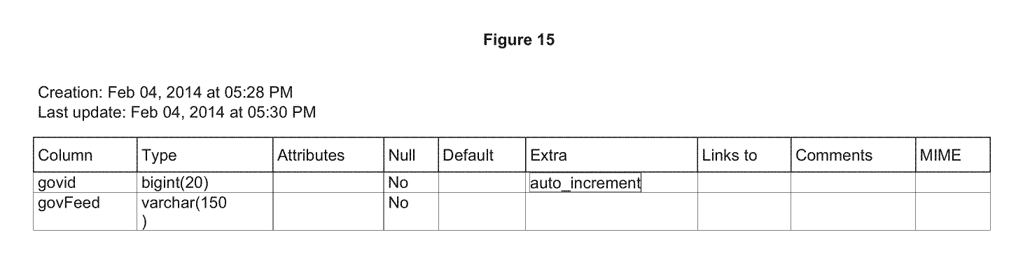

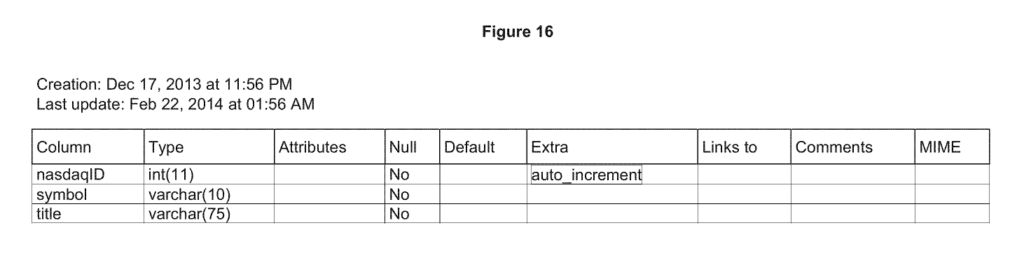

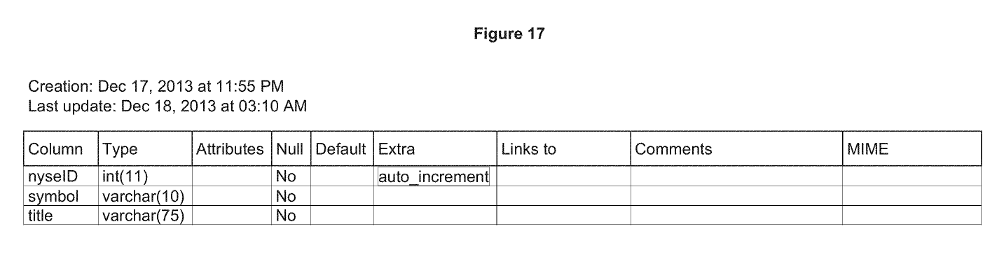

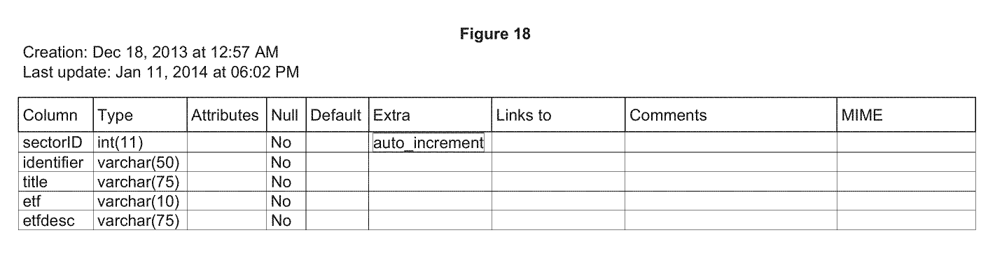

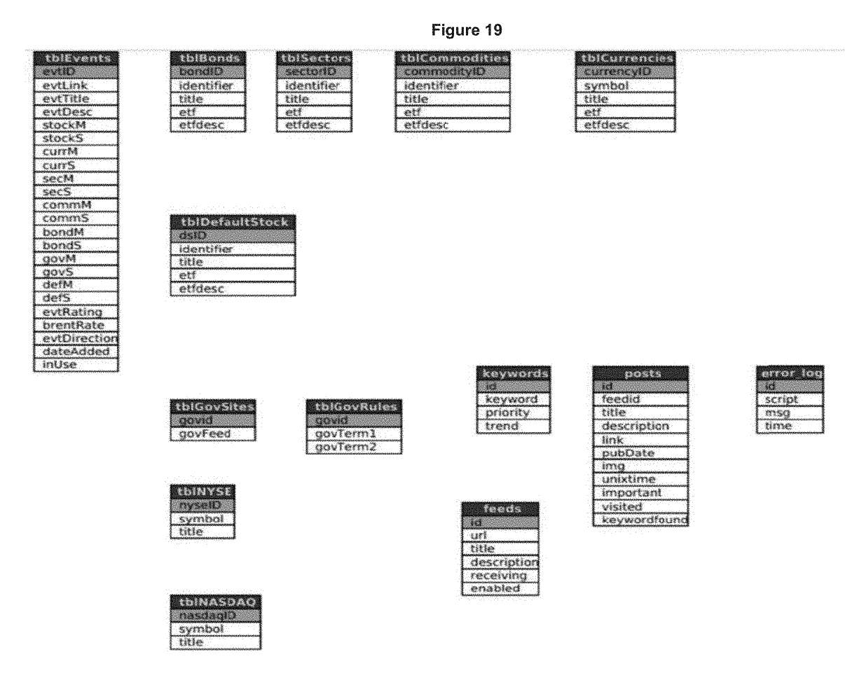

Referring to FIGS. 5-19, the invention first starts by executing structured query language that crawls an unlimited number of RSS XML feeds from government (.gov and .us sites) and reveals the source of news articles, press releases, announcements, rulings, bills, votes, etc. Unlimited numbers of keywords can be searched. The parser pulls the content from the meta-search using MySQL. The search web application is built using HTML/CSS/ and Twitter Bootstrap, while JavaScript is used for interactive components. The database software is MySQL and the language used is SQL. The search includes governmental events and political events that happen in municipal governments, state governments, the U.S. federal governments and international governments. It also searches news and events and public domain databases from the governments and courts of individual countries, along with international organizations—such as the European Commission and the European Union.

A script runs every 10 minutes, visits the URLs one by one, and checks for new content. If it finds a match or a “hit”, the script will search the article for predetermined and stored keywords and marks them important or not. If the article is determined important or a “match” or “hit,” the script will display a snippet of the content with a link to the full content. The script will also increment by one the keyword numerical count or trending count in order for the user to see the most or least popular matches for any given key word.

Asynchronous programming for the script that pulls the data from the Internet can be developed into a method that will visit two or more URLs at a time; this way the web application will decrease the time that the web crawler spends running.

User Interface features preferably include unlimited URL feeds and unlimited search terms and a split screen that displays all feeds on one side and relevant or “keyword matches” on the other. Each item on both feeds can be deleted. A user can choose different refresh times or select “auto-refresh.” The web application keeps track of “trending” key words. Photos included in content are visible on feeds. Users can select the number of feeds to be visible on the front end design of content items (20, 100, or 500). Keywords are highlighted after search terms are entered. Both feeds and search key words are highlighted in different colors depending on if they are working and active, added to memory, or not working.

The user decides which RSS XML feeds to search and decides which keywords the number of keywords or search terms is unlimited, as are number of RSS XML feeds that the search engine will look for.

A “feeds” table includes over 200 news feeds in RSS format. RSS is a form of XML (Extensible Markup Language) that contains titles of the news articles and descriptions, as well as their following web hyperlink. The government open source RSS feeds can draw from municipal governments, state governments, state legislatures, U.S. Congress, U.S. federal executive branch, the White House and international government web sites and databases. For these feeds, the invention searches numerous .gov or .us (local, state, or federal government feeds). For example, .gov feeds would include information from the U.S. Federal Drug Administration and Congressional committees.

The GovBrain search engine runs many times hourly to visit each of these feeds. This process is performed by PHP language on a Linux server. The PHP software code visits each of these feeds and stores their results by doing a CURL grab of the actual RSS XML so the invention can later analyze each individual feed and each article one by one.

A table called “Keywords” contains over 5,000 keywords to match to each subject that is analyzed. The invention first checks the title, and then the description against these keywords. These matches go into the posts table which is a larger table of “all result matches.” Once the invention accomplishes this, it does a secondary pass on the original feeds data for the Events table with a different set of rules.

For the entire Events table, there are many different tables that are used to provide a more finely-grained match of a given subject we want to target for later prediction. The “Bonds” table is comprised of bonds that have been targeted using keywords. This includes the name of the bond, a description, and then a symbol or identifier when there is a match. The resulting symbol is called the “Cashtag.” These are typically the ticker symbol for exchange traded funds. “BND” is the ticker for the exchange traded fund that trades publicly and tracks a global bond index. Here is an example of the Bonds table:

| | | |
|---|---|---|
| U.S. Bonds | BND | Vanguard Total Bond Market |

Now there is a title named “U.S. Bonds”, an ETF (Exchange Traded Fund) symbol of BND, and an ETF Description of “Vanguard Total Bond Market.” In the event search logic, the invention would match against the terms of the title, or “ETF Desc.” So if the title of the Bond matched one from the feed articles, it would be marked as a Bond match and stored accordingly as an event the prediction engine would later analyze.

The invention also concurrently matches against “Stocks” tables, in addition to Commodities, Sectors, Currencies, and Government tables. So each article that is pulled from each feed is run through these matching rules. For stocks, there are full NYSE and NASDAQ tables that contain each of the stock symbols and company names that are currently in trade on these markets. If there is a match on any of these stock symbols or company names, each of these results is tagged with a stock match and the company name and symbol are then also stored in “Events.”

Below is an example from the Commodities table:

| | | |
|---|---|---|
| Agriculture | DBA | Powershares Agriculture Fund |

Thus the invention matches in the same way it did for Bonds and Stocks before. If the article contains “Agriculture” it is a match and tagged as such for the Events table.

For currencies, the invention also matches against the actual universal English symbol for the currency. In this case, the “NZD,” would be linked to the New Zealand Dollar. The invention does the same for the “USD” for the U.S. Dollar, “MXN” for the Mexican Peso, and so forth for other global currencies.

Moreover, there is a set of unique rules just for Government. In this case a combination of “term1” and “term2” from the “GovRules” table is used in which both terms must be present. In this action, “term1” is used only at times when just one term must be present. An example of this combination is below:

| | | |
|---|---|---|
| 7 | central bank | monetary policy |

In the above example, in order for the article to be a Government match suitable to be added to the Events table, it must contain both “central bank” and “monetary policy” inside its text. In addition to these added finer-grained rules for Government, the invention also has another table which has feeds unique to Government called “GovSites.” If the invention examines one of these feeds in particular and the article comes from that feed, it will be tagged as a Government match, if it passes the rules explained above.

After passing through the rules of each rule table including tblGovRules, tblBonds, tblCommodities, tbINYSE, tbINASDAQ, tblCurrencies, tblSectors, and tblDefaultStock, the invention either has a match, a mix of matches, or no match. If there is no match, nothing is stored in the Events table. If there is a match, it could be a mix of Stock, and Government, or any other, or it could simply have matched only once on the various set of rules. Once the invention determines there is a match, this data is now stored as its own Event to “tblEvents.”

The table below illustrates an example match:

| | | IIA Backs FCC Action to | | | | | | | | | | | |
|---|---|---|---|---|---|---|---|---|---|---|---|---|---|
| ID | http://internetinnovation. | Initiate Local, High- | | | | | | | | | | | |
| 1298 | org/blog/comments/iia-ba | Speed. | 0 | 0 | 0 | 1 | Energy | 0 | 0 | 0 | 5 | Null | 2 |

This is how the invention works to store the matching URL of the article, the title, and the description. In addition, the invention stores what type of match it was, and more.

The following describes the invention's “prediction engine.” This is a description of how the invention predicts the security price direction and strength of the security price move. For the prediction engine, the objective is to take much of this data and use for it for analyzing the political or governmental event. This process finally yields a rating of either “positive,” “negative” or “neutral” for the security or asset price and the strength of that price move.

To achieve these ratings and predictions, the invention uses a form of artificial intelligence or machine language. First the prediction engine had to be trained. The training data used for the prediction engine is based on ratings of past GovBrain event data by an expert. The expert rated a large subset of event data estimated at around 4,000 results obtained by using a “test” feature on the prediction web application. This data was then sent by the invention to the Google Prediction Engine that analyzes the expert's professional rating, the Event Title, and the Event Description. Now that the prediction engine has been trained by a human, the invention is equipped to parse future political and governmental events along with the automatic matching of the events to financial assets or securities. Then the invention's prediction engine automatically predicts the security or asset price move and strength of the price move.

In order to rate these articles using the new Artificial Intelligence trained by the expert, there is a separate PHP Engine running after each Event insert. This runs immediately following a new Event insert. In this action, the expert's test rating passes the Event title and description to the prediction engine, and it sends back a rating based on previous ratings and the text of each article or government event.

Therefore, the following describes the invention's systemic approach that uses various web applications to accomplish the tasks and solutions explained above.

### Web App One (Main Product)

This GovBrain web app automatically links a government/political event to a stock, bond, currency, commodity or ETF along with its “Cashtag” ticker symbol and predicts the security price move/sentiment (Bullish, Bearish, or Neutral) and the intensity or strength of that move. The predictive analysis of the price move/sentiment and intensity is performed automatically by artificial intelligence.

### Web App Two

This GovBrain web app is for traders and analysts who wish to make their own predictions without the computer software's artificial intelligence. It shows a rolling feed of government/political events and news that affect various stocks, bonds, currencies and commodities without the “cash tag.” Users can search for specific companies to do their own research for anything from mergers and acquisition arbitrage to pairs trading.

### Web App Three

This GovBrain web app consists of an automated database or archival system for our price predictions and events. The app automatically stores each government event along with the ticker, date, time, GovBrain price prediction, intensity, open, close, high, low, volume, 52-week range, and moving averages.

Additionally, the GovBrain system of web applications is not just for securities trading or investing. It can be used for custom reports for general business intelligence and research. It can provide customized reports that predict whether a municipal, state, federal or international piece of legislation or bill passes of fails to pass. It can also be used for mergers and acquisitions arbitrage, due diligence, sale or purchase of bonds or other fixed income instruments, foreign currency sales or purchases, risk arbitrage, pairs trading, technical analysis across asset classes, industry sector research, purchase or sales of derivatives such as options, puts, and futures, commodity research and commodity purchases and sales.

In the preferred embodiment, and as readily understood by one of ordinary skill in the art, the apparatus according to the invention will include a general or specific purpose computer or distributed system programmed with computer software implementing the steps described above, which computer software may be in any appropriate computer language, including C++, FORTRAN, BASIC, Java, assembly language, microcode, distributed programming languages, etc. The apparatus may also include a plurality of such computers/distributed systems (e.g., connected over the Internet and/or one or more intranets) in a variety of hardware implementations. For example, data processing can be performed by an appropriately programmed microprocessor, computing cloud, Application Specific Integrated Circuit (ASIC), Field Programmable Gate Array (FPGA), or the like, in conjunction with appropriate memory, network, and bus elements.

Note that in the specification and claims, “about” or “approximately” means within twenty percent (20%) of the numerical amount cited. All computer software disclosed herein may be embodied on any non-transitory computer-readable medium (including combinations of mediums), including without limitation CD-ROMs, DVD-ROMs, hard drives (local or network storage device), USB keys, other removable drives, ROM, and firmware.

Although the invention has been described in detail with particular reference to these preferred embodiments, other embodiments can achieve the same results. Variations and modifications of the present invention will be obvious to those skilled in the art and it is intended to cover all such modifications and equivalents. The entire disclosures of all references, applications, patents, and publications cited above and/or in the attachments, and of the corresponding application(s), are hereby incorporated by reference.

What is claimed is:

1. A method of automated repeat searching for information regarding new government or regulatory events related to a topic, the method comprising the ordered steps of:
receiving keywords from a user deemed relevant by the user to the topic;
by computer, using the keywords, identifying potentially relevant government or regulatory events relating to the topic and not previously identified;
parsing the potentially relevant government or regulatory events;
by pattern matching using the keywords, automatically determining a level of relevance of the potentially relevant government or regulatory events to the topic;
reporting relevant new government or regulatory events located for which the level of relevance exceeds a predetermined threshold; and
returning to the identifying step.

2. The method of claim 1 additionally comprising the step of assigning a sentiment value to each relevant new government or regulatory event with respect to the topic.

3. The method of claim 1 wherein all potentially relevant government and regulatory events are public information.

4. The method of claim 1 wherein a source of the potentially relevant government and regulatory events is one or more RSS XML (Rich Site Summary Extensible Markup Language) feeds from one or more of municipal, state, federal, international governments, international bodies, and quasi-governmental organizations.

5. The method of claim 1 additionally comprising having the user specify information feeds to be searched.

6. The method of claim 1 wherein the method operates on a plurality of topics simultaneously.

7. The method of claim 1 additionally comprising the step of training an automated prediction engine via a human expert for use in the determining step.

8. Non-transitory computer readable medium comprising computer software for automated repeat searching for information regarding new government or regulatory events related to a topic, the computer software comprising computer-readable code comprising:
code receiving keywords from a user deemed relevant by the user to the topic;
code using the keywords, identifying potentially relevant government or regulatory events relating to the topic and not previously identified;
code parsing the potentially relevant government or regulatory events;
code automatically by pattern matching using the keywords determining a level of relevance of the potentially relevant government or regulatory events to the topic;
code reporting relevant new government or regulatory events located for which the level of relevance exceeds a predetermined threshold; and
code returning to the identifying code; and
wherein the code executes in the order listed.

9. The non-transitory computer readable medium of claim 8 additionally comprising code assigning a sentiment value to each relevant new government or regulatory event with respect to the topic.

10. The non-transitory computer readable medium of claim 8 wherein all potentially relevant government or regulatory events are public information.

11. The non-transitory computer readable medium of claim 8 wherein a source of the potentially relevant government or regulatory events is one or more RSS XML (Rich Site Summary Extensible Markup Language) feeds from one or more of municipal, state, federal, international governments, international bodies, and quasi-governmental organizations.

12. The non-transitory computer readable medium of claim 8 additionally comprising code having the user specify information feeds to be searched.

13. The non-transitory computer readable medium of claim 8 wherein the software operates on a plurality of topics simultaneously.

14. The non-transitory computer readable medium of claim 8 additionally comprising code reflecting training of an automated prediction engine via a human expert for use with the determining code.

15. Apparatus for automated repeat searching for information regarding new government or regulatory events related to a topic, said apparatus comprising:
a computer or computers receiving keywords from a user deemed relevant by the user to the topic;
a computer or computers using the keywords, identifying potentially relevant government or regulatory events relating to the topic and not previously identified;
a computer or computers parsing the potentially relevant government or regulatory events;
a computer or computers automatically by pattern matching using the keywords determining a level of relevance of the potentially relevant government or regulatory events to the topic;
a computer or computers reporting relevant new government or regulatory events located for which the level of relevance exceeds a predetermined threshold; and
a computer or computers returning execution to the identifying computer or computers; and
wherein the apparatus operates the search in the order listed.

16. The apparatus of claim 15 additionally comprising a computer or computers assigning a sentiment value to each relevant new government or regulatory event with respect to the topic.

17. The apparatus of claim 15 wherein all potentially relevant government or regulatory events are public information.

18. The apparatus of claim 15 wherein a source of the potentially relevant government or regulatory events is one or more RSS XML (Rich Site Summary Extensible Markup Language) feeds from one or more of municipal, state, federal, international governments, international bodies, and quasi-governmental organizations.

19. The apparatus of claim 15 additionally having the user specify information feeds to be searched.

20. The apparatus of claim 15 wherein the apparatus operates on a plurality of topics simultaneously.

21. The apparatus of claim 15 additionally comprising a database reflecting training of an automated prediction engine via a human expert for use with the determining computer or computers.
